(19) United States
(12) Patent Application Publication
(10) Pub. No.: US 2008/0126667 A1
(43) Pub. Date: May 29, 2008

(54) Method for controlling storage devices

(76) Inventors: Norichika Hatabe, Yokohama (JP); Hiroyuki Takabayashi, Yokohama (JP); Takeaki Murakoso, Hiratsuka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/605,263

(22) Filed: Nov. 29, 2006

(30) Foreign Application Priority Data
Sep. 22, 2006 (JP) 2006-257133

(51) Int. Cl. G06F 12/02

(52) U.S. Cl. 711/4; 707/205; 711/E12.002

(57) ABSTRACT

A technology in which a magnetic disk apparatus executes data relocation involves the problems how to cope with new setup of file management and hardware failure and performance drop at the time in a data relocation. The invention provide a technology capable of executing data relocation without moving physical data position by a magnetic disk control apparatus when a disconnection operation of a logical volume is made, while keeping setup of an existing file management system. Therefore, the magnetic disk control apparatus is provided with means for keeping a file position information list inside a logical volume, executing optimal data reorganization in such a fashion as to eliminate fragmentation of the list and updating a physical/logical address mapping table. Reorganization of the logical file position is made without the data movement.

### INCORPORATION BY REFERENCE

The present application claims priority from Japanese application JP2006-257133 filed on Sep. 22, 2006, the content of which is hereby incorporated by reference into this application.

### BACKGROUND OF THE INVENTION

This invention relates to a technology for controlling storage areas in a storage device.

When accesses such as data generation, deletion, additional write, etc, are repeatedly made to a storage device such as magnetic disk device, a continuous area large enough to store a large file cannot be secured and files are located under a fragmented state.

A technology customarily employed in the past expands file position information stored in a volume onto a memory of a computer and gains access to a file on a storage device by looking up the information. When the file is fragmented at the time of this access to the file on the storage device, however, the file position information must be looked the number of times which is the same as the number of fragmentation, and consumption of the memory due to the increase of the file position information and the drop of access performance to the file on the storage device may occur.

To improve the access performance to the data on the storage device in the case where the data on the logical volume that can be seen from a host computer is fragmented, an ordinary technology executes data relocation (de-fragmentation) for releasing the data from the fragmentation state through the control of the host computer.

A technology that allows a storage device to execute data relocation without control from a host computer is known, too (refer to JP-A-2004-334419, for example).

### SUMMARY OF THE INVENTION

According to the technology that executes data relocation through the control of the host computer, however, the host computer needs to monitor the fragmentation state of the logical volumes and to execute data relocation. Therefore, the problem remains unsolved that resources of a CPU and a memory are consumed and a large load is applied to the host computer.

According to the technology that allows the storage device to execute data relocation without control from the host computer, the load to the host computer can be reduced. However, the function of managing the positions of the files (physical addresses) on the storage device must be mounted and the function of file management must also be mounted to the host computer and to the storage device, thereby calling for enormous labor.

It is therefore an object of the invention to provide a technology that improves access performance to data on a storage device without applying a large load to a host computer and without requiring enormous labor for mounting a file management function to the storage device.

To accomplish the object described above, a storage device control apparatus according to the invention holds file position information inside a logical volume, executes relocation of a file position on the basis of the position information, and rewrites a physical/logical address mapping table. Accordingly, the invention can improve access performance to data on a storage device without applying a large load to the host computer and without requiring enormous labor for mounting a file management function to the storage device.

Other objects, features and advantages of the invention will become apparent from the following description of the embodiments of the invention taken in conjunction with the accompanying drawings.

### BRIEF DESCRIPTION OF THE DRAWINGS

FIG. 1 shows a construction of an entire computer system inclusive of a storage device according to a first embodiment of the invention;

FIG. 2 shows an example of a logical volume management table in the first embodiment of the invention;

FIG. 3 shows an example of a file position information list in the first embodiment of the invention;

FIG. 4 shows an example of a reorganization journal in the first embodiment of the invention;

FIG. 5 shows an example of a physical/logical address mapping table in the first embodiment of the invention;

FIG. 6 is a processing flowchart about a reorganization processing to satisfy a disconnection request of a logical volume in the first embodiment of the invention;

FIG. 7 is a processing flowchart about a reorganization processing in the first embodiment of the invention;

FIG. 8 shows a reorganization execution example of a file position information list in the first embodiment of the invention;

FIG. 9 shows an example of an updating example of a physical/logical address mapping table in the first embodiment of the invention;

FIG. 10 is a processing flowchart about a reorganization processing to satisfy a connection request of a logical volume in the first embodiment of the invention;

FIG. 11 shows a construction of an entire computer system inclusive of a storage device according to a second embodiment of the invention; and

FIG. 12 is a processing flowchart about a reorganization processing to satisfy a disconnection request of a logical volume in the second embodiment of the invention.

### DESCRIPTION OF THE EMBODIMENTS

The best mode for carrying out the invention (hereinafter called “embodiment(s)”) will be explained. Incidentally, the invention is in no way limited to these embodiments.

### First Embodiment

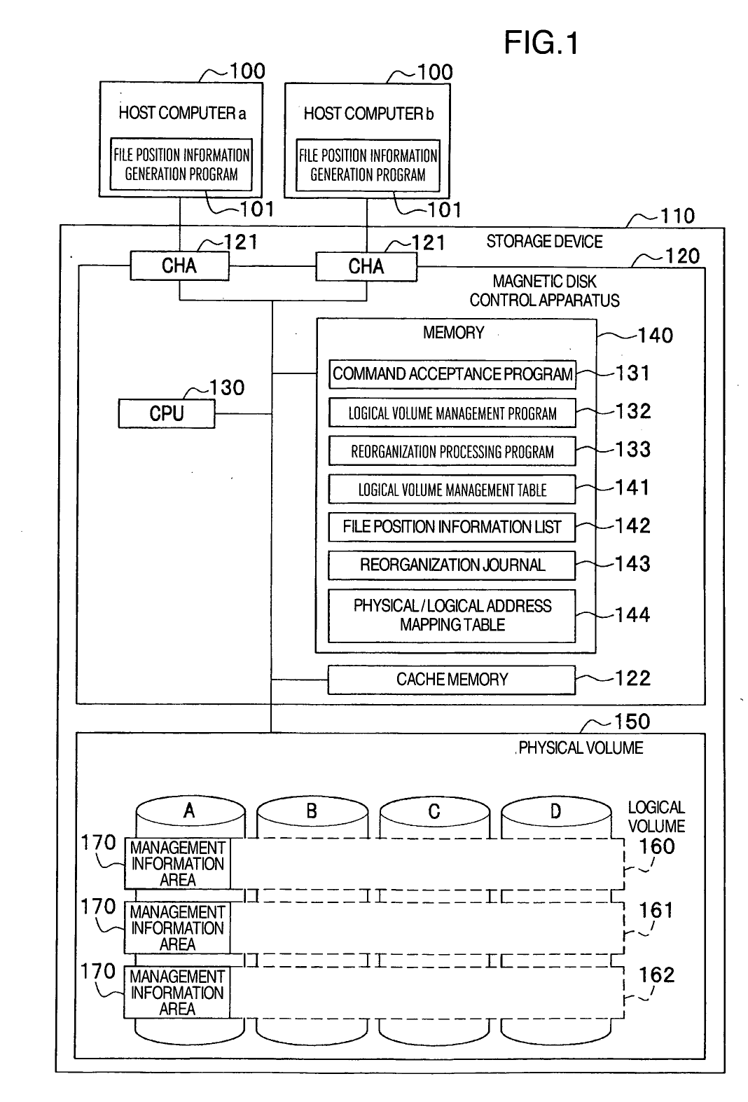

FIG. 1 shows a system construction according to a first embodiment of the invention. In the system construction shown in FIG. 1, host computers (computers) (a, b) 100 are connected to a storage device 110. The embodiment of the invention needs a system construction in which at least one host computer 100 and at least one storage device 110 are connected to each other in such a fashion as to be capable of executing mutual communication.

The host computer 100 is the one that a user uses and is a PC (Personal Computer), a work station or a main frame, for example. The host computer 100 utilizes various functions provided by the storage device 110 by transmitting commands (requests) to the storage device 110.

A magnetic disk control apparatus (storage device control apparatus) 120 includes a channel adaptor 121 (hereinafter called “CHA”), a cache memory 122, a CPU (Central Processing Unit) (processing portion) 130, a memory (storage portion) 140 and a connection portion such as paths and switches for connecting these portions. The memory 140 stores various programs such as a command acceptance program 131 for controlling the command received from the host computer 100, a logical volume management program 132 for managing the information of the logical volumes 160 to 162 and giving an instruction of reorganization and a reorganization processing program 133 for executing reorganization. Various functions are achieved when the CPU 130 inside the magnetic disk control apparatus 120 executes these programs. Incidentally, this embodiment uses the magnetic disk control apparatus 120 as the storage device but a storage device such as a semiconductor memory can be used, too.

The command acceptance program 131 is the program for executing various controls for data storage in accordance with the commands the CHA 121 receives from the host computer 100. When an input/output command for the physical volume 150 is received from the host computer 100, for example, an input/output processing is executed through a cache memory 122. The command acceptance program 131 receives also various commands for managing the storage device 110 from the host computer 100. Furthermore, the command acceptance program 131 can set a logical device (LDEV) on an RAID group by setting a disk array (RAID (Redundant Arrays of Inexpensive Disks) group) to a group of the physical volume 150, and can execute control in a predetermined RAID system.

Data is stored in a storage area (logical volumes 160 to 162) logically set on a physical storage area on the physical volume 150. The physical volume 150 has position information (physical address) for identifying at which position of the physical storage area on the magnetic disk the data is located. Similarly, each logical volume 160 to 162 has position information (logical address) for identifying at which position of the logical storage area the data is located. The cache memory 122 is mainly used for storing the data. The memory 140 is used for storing various kinds of control information.

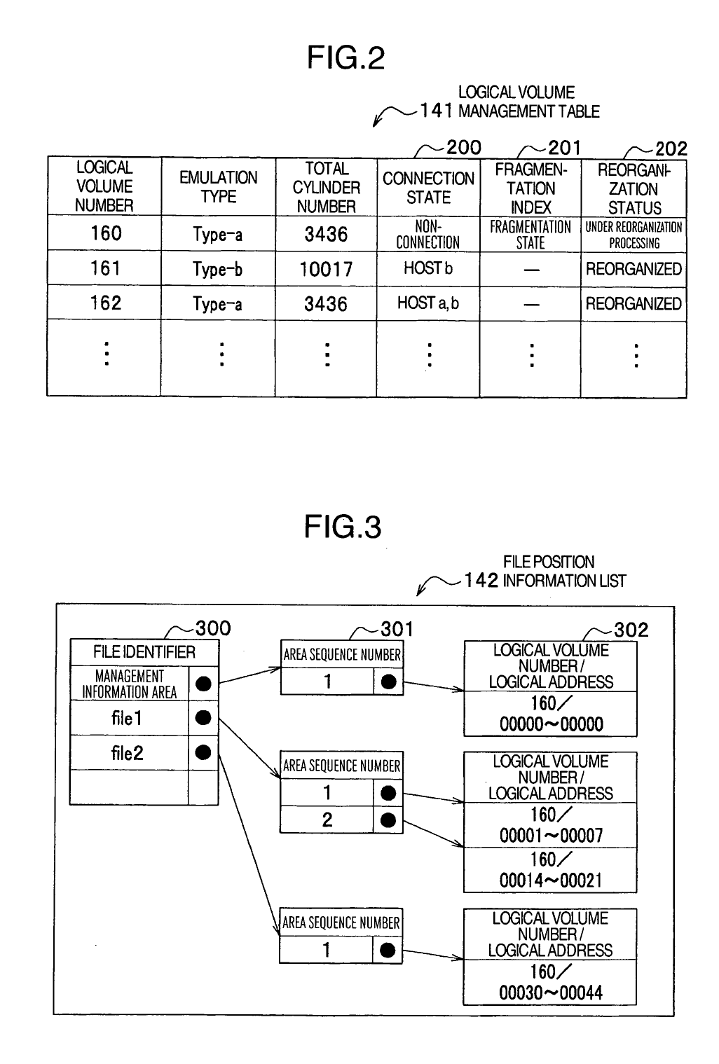

The logical volume management program 132 is a program for managing information of the logical volume 160 to 162 defined in the storage device 110. In this embodiment, reorganization is executed by managing a connection state between the host computer 100 and the storage device 110 to be stored in the logical volume management table 141 and a data fragmentation state inside the logical volume 160 to 162. The logical volume management program 132 updates a connection state 200 (see FIG. 2) of the logical volume management table 141 depending on the connection state with the host computer 100 when the logical volume 160 to 162 defined in the logical volume management table 141 is connected (is mounted). When the logical volume 160 to 162 is disconnected (is de-mounted), calculation of a fragmentation index of the volume is instructed to the reorganization processing program 133 and the fragmentation index 201 (see FIG. 2) of the logical volume management table 141 is updated by the fragmentation index so determined. A reorganization processing is instructed to the reorganization processing program 133 on the basis of this fragmentation index, whenever necessary. The information as the opportunity of the execution of reorganization (threshold value of the fragmentation index for executing reorganization processing) can be acquired by a method that acquires it at the time of definition of the logical volume 160 to 162 or a method that acquires it from the host computer 100 at the time of the disconnection request of the logical volume 160 to 162.

The reorganization processing program 133 is a program for executing a processing for reorganization inside the logical volume 160 to 162 by the instruction of the logical volume management program 132. When receiving the instruction for calculating the fragmentation index from the logical volume management program 132, the reorganization processing program 133 calculates the fragmentation index of the object logical volume 160 to 162. Similarly, when receiving the instruction of reorganization from the logical volume management program 132, the reorganization processing program 133 executes reorganization for the object logical volume 160 to 162. The term “reorganization” used hereby means the re-write operation of the correspondence between the physical address and the logical address managed by the physical/logical address mapping table 144 but not the movement of data and the change operation of the file position on the logical volume 160 to 162. In this way, files divided into a plurality of files on the logical volumes 160 to 162 can be turned into one continuous file without involving actual data movement, and a continuous space area can be secured by changing the file position.

File position information list 142 containing information for associating the file inside the logical volume 160 to 162 with the logical address and information of the space area inside the logical volume 160 to 162 is used for reorganization. This file position information list 142 is generated as a file position information generation program 101 of the host computer 100 is executed by the CPU (not shown) of the host computer 100. To execute reorganization, the file position information list 142 is first reorganized and data of a reorganization journal (reorganization history information) 143, that becomes necessary for updating the data of the physical/logical address mapping table 144 and the management information area 170 on the logical volume 160 to 162, is collected. The reorganization journal 143 is journal data representing the history of the reorganization processing. The reorganization journal 143 can be utilized when updating of the physical/logical address mapping table 144 and the management information area 170 proves unsuccessful and the information is returned to the original information.

FIG. 2 shows an example of the logical volume management table 141 (see FIG. 1). The logical volume management table 141 (see FIG. 1) will be explained with reference to FIG. 2 (with appropriate reference to FIG. 1). The logical volume management table 141 manages various kinds of information of the logical volume 160 to 162 defined inside the storage device 110. For example, an emulation type (Type-a), a total cylinder number (3436CYL), the connection state with the host computer 100 (non-connection), the fragmentation index of the data (fragmentation state) and the reorganization status 202 (under reorganization processing) are stored as the information 160 of the logical volume No. 160. Here, besides the logical volume number, the logical volume management table 141 contains the connection state 200, the fragmentation index 201 and the reorganization state 202 and each will be explained.

The connection state 200 represents the logical connection state between the host computer 100 and each logical volume 160 to 162 and the information for identifying the host computer 100 is stored when connection is established. The term “logical connection” hereby used means the state where the logical volume 160 to 162 is mounted/de-mounted, the connection state is the on-line/off-line state or the connection state when the magnetic disk control apparatus 120 has a mechanism for disconnecting the logical volume 160 to 162. Therefore, the term is different from the physical connection such as connection of paths.

The fragmentation index 201 represents the fragmentation state inside the logical volume 160 to 162 calculated in the reorganization processing program 133. The continuous area number inside the logical volumes 160 to 162 is an example of this fragmentation index. When a file is divided into a plurality of files or when a space area exists inside the logical volume, this continuous area number becomes great and represents that the logical volumes 160 to 162 are fragmented.

The reorganization status 202 represents the reorganization updating state between the file position information list 142 managed inside the magnetic disk control apparatus 120 and the management information area 170 inside the logical volume 160 to 162. This reorganization status 202 represents, for example, “under reorganization processing” where the reorganization processing is being executed inside the magnetic disk controller 120 and the management information area 170 is not yet reorganized and the “reorganized state” where the reorganization processing is fully completed, or fragmentation is not made and reorganization is not necessary.

FIG. 3 shows an example of the file position information list 142 (see FIG. 1). The file position information list 142 (see FIG. 1) will be explained with reference to FIG. 3 (appropriate reference to FIG. 1). The file position information list 142 has information such as a file identifier 300 that manages the files inside the logical volume 160 to 162 in association with the logical address and stipulates the file, an area sequence number 301 that represents the sequence of each area when the file is divided, and a logical volume number/logical address 302 that stipulates the file position on the logical volumes 160 to 162. For example, the information of the file identifier file1 divided into two areas is managed as area sequence numbers 301 (1,2) and the respective logical volume number(s)/logical address(es) 302 (160/00001 to 00007, 160/00014 to 00021). It would also be possible to contain the information, as effective information for reorganizing in the magnetic disk control apparatus 120, of the space areas inside the logical volumes 160 to 162.

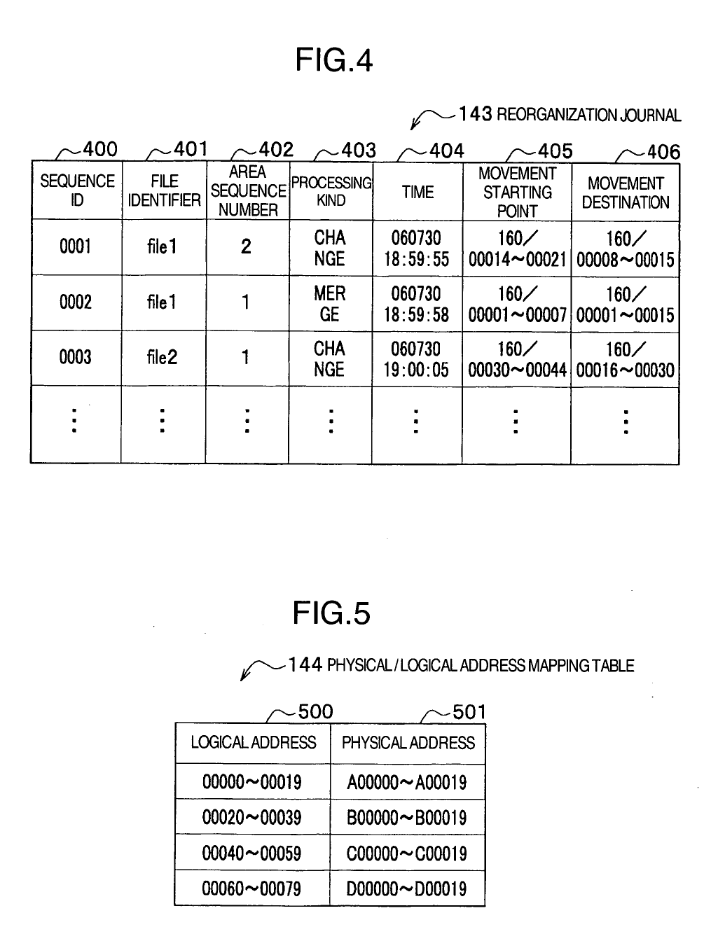

FIG. 4 shows an example of the reorganization journal 143 (see FIG. 1). The reorganization journal 143 (see FIG. 1) will be explained with reference to FIG. 4 (with appropriate reference to FIG. 1). Journal data as the history information when the reorganization processing is executed for the file position information list 142 is stored in the reorganization journal 143. The items of the reorganization journal 143 include a sequence ID 400 as the sequence number of execution of reorganization, a file identifier 401 and an area sequence number 402 for identifying the reorganized file, a processing kind 403 representing the change (CHANGE) of the file position information and a merge (MERGE) of the file position information, a time 404 representing the execution date and time of the processing, and a movement starting point 405 and a movement destination 406 representing the logical volumes 160 to 162 and the range of the logical address when reorganization is made. The data of the sequence ID 0001, for example, represents the processing that changes (CHANGE) the data of the area sequence number “2” to the position immediately after the area sequence number “1” so that the file1 divided into two files forms a continuous area. In consequence, since the file1 forms one continuous area, the processing represented by the data of the sequence ID0002 merges (MERGE) the information of the area sequence number “2” with the information of the area sequence number “1”. In the processing represented by the data of the sequence ID0003, the file 2 is changed (CHANGE) to the position immediately after the file1 to secure a continuous space area.

FIG. 5 shows an example of the physical/logical address mapping table 144 (see FIG. 1). The physical/logical mapping table 144 (see FIG. 1) will be explained with reference to FIG. 5 (with appropriate reference to FIG. 1). The physical/logical address mapping table 144 manages the logical address 500 inside the logical volume 160 to 162 in association with the physical address 501 on the physical volume 150. For example, the information representing that the logical addresses 00000 to 00019 correspond to the physical addresses A00000 to A00019 is stored. When this correspondence between the logical address 500 and the physical address 501 is rewritten, the data on the logical volume 160 to 162 can be effectively reorganized without involving the movement of the data.

The features of the first embodiment explained hereby are as follows. Namely, the features of this embodiment are that the magnetic disk control apparatus 120 is not aware of the file system when the host computer 100 uses the logical volume 160 to 162, and that the host computer 100 has the file position information generation program 101 and generates the file position information list 142 of a uniform system irrespective of the kind of the host computer 100 when the program is executed by the CPU (not shown) of the host computer 100.

In the system shown in FIG. 1, the processing for executing reorganization at the time of the disconnection request of the logical volume 160 to 162 and at the time of connection request of the logical volume 160 to 162 will be explained.

### <At Disconnection Request of Logical Volume>

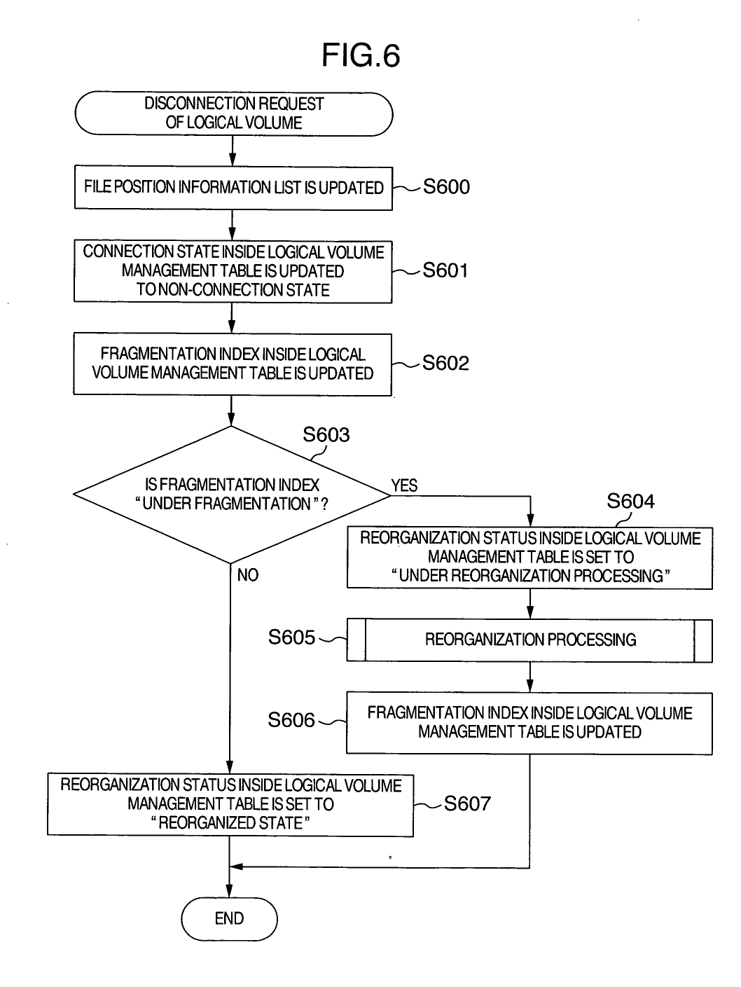

FIG. 6 shows a reorganization processing flow at the time of the disconnection request of the logical volume. The reorganization processing at the time of the disconnection request executed by the CPU 130 will be explained with reference to FIG. 6 (with appropriate reference to FIGS. 1 to 5). When the host computer 100 requests the storage device 110 to disconnect the logical volume 160 to 162, the CPU (not shown) of the host computer 100 executes the file position information generation program 101 and generates and transmits the file position information list 142 to the storage device 110. The CPU 130 updates the file position information list 142 managed inside the magnetic disk control apparatus 120 (step S600). At this time, information as the opportunity of execution of the reorganization processing may be handed over to the magnetic disk control apparatus 120 from the host computer 100. This information contains an option that the judgment condition of the fragmentation index and reorganization are executed without fail and an option that reorganization is not executed. The information is set by the method that hands over at the time of the disconnection request of the logical volume 160 to 162 or the method that defines in advance the information to the magnetic disk control apparatus 120 at the time of definition of the logical volume 160 to 162 or at the time of initialization.

As the CPU 130 executes the logical volume management program 132 inside the magnetic disk control apparatus 120 in accordance with the disconnection request of the logical volume 160 to 162, the connection state 200 (of the object volume) inside the volume management table 141 is updated to the non-connection state (step S601) and gives an instruction of calculation of the fragmentation index inside the logical volume 160 to 162 to the reorganization processing program 133.

As the CPU 130 executes the reorganization processing program 133, it calculates the fragmentation index from the file position information list 142 and the logical volume management table 141 managed inside the magnetic disk control apparatus 120. An example of the calculation method acquires the total cylinder number from the logical volume management table 141, calculates the range of the logical addresses of the object logical volumes 160 to 162 from the total cylinder number and determines the fragmentation state from the range and the file position information list 142 representing the data storage information inside the object logical volume 160 to 162. The fragmentation index so calculated is handed over to the logical volume management program 132 and the CPU 130 executes he logical volume management program 132 so that the fragmentation index 201 inside the logical volume management table 141 can be updated by the fragmentation index received from the reorganization processing program 133 (step S602). Here, whether or not the fragmentation index determined is under the “fragmentation state” is judged (step S603). Incidentally, various standards may be available for judging whether or not the state is under the fragmentations state, such as a method that judges the fragmentation state when a ratio of the number of continuous areas of the file is greater than a predetermined value.

When the fragmentation index is not the “fragmentation state” (“No” in step S603), reorganization need not be executed. Therefore, the reorganization status 202 inside the logical volume management table 141 is set to “reorganized” (step S607) and the processing is completed.

When the fragmentation index is under the “fragmentation state” (“Yes” in step S603), it is necessary to execute reorganization. Therefore, the reorganization status 202 inside the logical volume management table 141 is set to “under reorganization processing” (step S604). An instruction of the execution of reorganization is given from the logical volume management program 132 to the reorganization processing program 133. The reorganization processing program 133 receives the instruction of the reorganization execution from the logical volume management program 132 and executes the reorganization processing as the CPU 130 executes the reorganization processing program 133 (step S605). The reorganization processing of the file position information list 142 and updating of the physical/logical address mapping table 144 are executed in the reorganization processing. At this time, the processing is executed by using a reorganization algorithm providing an optimal location so that a file divided into a plurality of files form a continuous area and a continuous space area can be secured. When reorganization is thus executed, the divided file position information is merged and the information managing the files can be reduced. When the reorganization processing is completed, the fragmentation index 201 inside the logical volume management table 141 is updated (step S606) and the processing is completed.

### [Reorganization Processing]

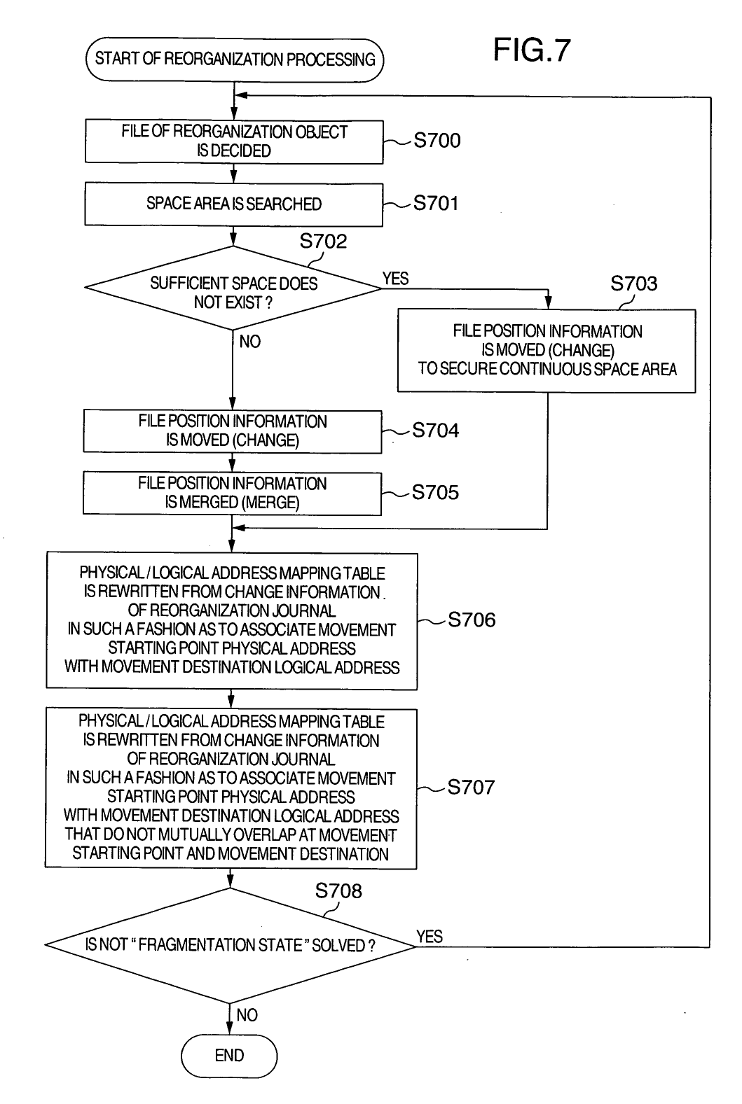

FIG. 7 shows a detailed flow of the reorganization processing (see FIG. 6). The detail of the reorganization processing executed by the CPU 130 will be hereinafter explained with reference to FIG. 7 (with appropriate reference to FIGS. 1 to 6). First, to merge the divided files into a continuous area, the file of the reorganization object is decided (step S700). The method of deciding the file of the reorganization object includes, for example, a method that decides the file on the basis of the area sequence number 301 of the file position information list 142. For example, there is a method that decides a file having a maximum value of the area sequence number 301 of at least 2 as the file of the reorganization object.

Next, a space area of the logical address necessary for reorganizing the selected file is searched by using the logical volume management table 141 and the file position information list 142 (step S701). Judgment of a sufficient space area is made (step S702). When the sufficient space area does not exist (“Yes” in step S702), the divided files cannot be merged into the continuous area. To secure the continuous space-area, therefore, the file position information is moved (CHANGE) (step S703). In other words, the file position information list 142 is updated so that the file can be moved to secure the continuous space area. The flow then proceeds to step S706. When the sufficient space area exists (“No” in step S702), the file position information is moved (CHANGE) (step S704) to merge the divided files into the continuous area and the file position information is merged (MERGE) as the continuous area (step S705). The file position information list 142 is updated so as to move the file in order to merge the divided files into the continuous area. Here, updating history of the file position information list 142 is serially stored in the reorganization journal 143. The flow then proceeds to step S706.

Updating of the physical/logical address mapping table 144 is executed by using the reorganization journal 143. First, the physical/logical address mapping table 144 is rewritten in such a fashion as to associate the movement starting point physical address with the movement destination logical address from the information (CHANGE information) acquired by changing the file position information of the reorganization journal 143 (step S706). Next, the physical/logical address mapping table 144 is rewritten in such a fashion as to associate the movement destination physical address not overlapping in the range with the movement starting point with the movement starting point logical address (step S707). Here, whether or not the fragmentation state of the file position information list 142 is solved is judged (step S708). The flow returns to step S700 when the fragmentation state is not yet solved (“Yes” in step S708) and the processing is completed when the fragmentation state is solved (“No” in step S708). When a file having a maximum value of an area sequence number 301 of at least 2 is decided as the file of the reorganization object, for example, the fragmentation state can be judged as being solved when the processing of the files having the maximum value of the area sequence number of 301 of at least 2 is fully completed.

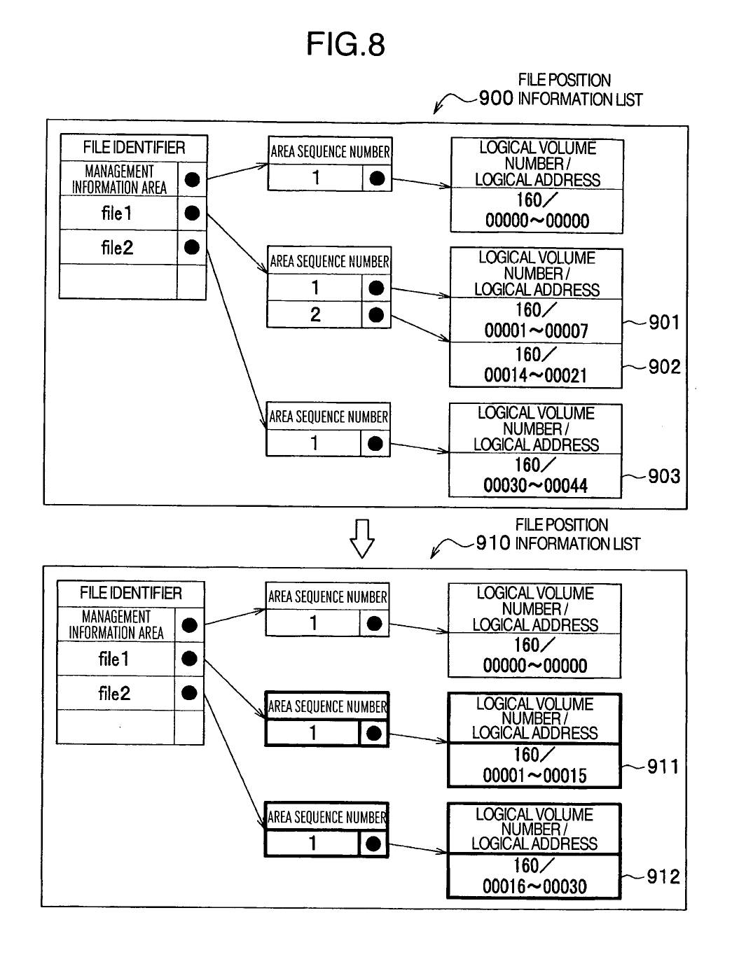

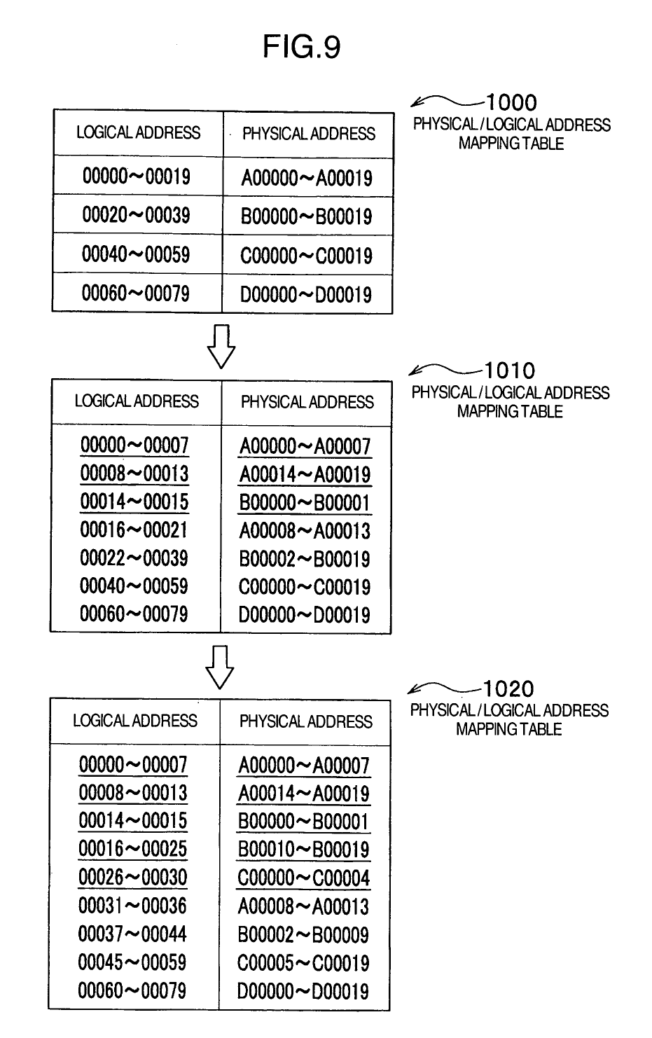

FIG. 8 shows the file position information list 142 (see FIG. 1) before and after the reorganization processing. FIG. 9 shows the physical/logical address mapping table 144 (see FIG. 1) before and after the reorganization processing. A concrete example of the reorganization processing executed by the CPU 130 will be hereinafter explained with reference to FIGS. 8 and 9 (with appropriate reference to FIGS. 1 to 5).

First, the file of the reorganization object is decided in the file position information list 900 before the reorganization. Here, the file identifier file1 divided into two parts is selected and data does not exist immediately after the area 901 of the area sequence number “1” (logical addresses 00001 to 00007) (space area sufficient to move the area 902 of the area sequence number “2” exists). Therefore, the file position information of file1 can be merged by moving the area 902 of the area sequence number “2” (logical addresses 00014 to 00021) to the position immediately after the area sequence number “1”. The result of this merge becomes the area 911 (logical addresses 00001 to 00015) in the file position information list 910 after the reorganization. The history of the execution of the reorganization becomes such as sequences ID0001 and 0002 in the reorganization journal 143 in FIG. 4.

From information of the sequence ID0001 in the reorganization journal 143 in FIG. 4, for example, the movement starting point logical addresses are 00014 to 00021 and the movement destination logical addresses are 00008 to 00015. From this information together with the physical/logical address mapping table 1000 not yet updated in FIG. 9, the physical addresses of the movement starting point are A00014 to A00019 and B0000 to B0001, and is associated with the movement destination logical addresses 00008 to 00015 in step S706 (see FIG. 6).

In the sequence ID0001 of the reorganization journal 143 shown in FIG. 4, for example, the range 00014 to 00015 of the logical address overlaps between the movement starting point and the movement destination. Therefore, association is already rewritten at this portion and it is the movement destination logical addresses 00008 to 00013 and the movement starting point logical addresses 00016 to 00021 for which association must be rewritten. From this information together with the physical/logical address mapping table 1000 shown in FIG. 9, the movement destination physical addresses are A00008 to A00013. Step S707 (see FIG. 6) associates these addresses with the movement starting point logical addresses 00016 to 00021.

In the sequence ID0001 shown in FIG. 4, therefore, the physical/logical address mapping table 1000 is updated so that the logical addresses 00008 to 00021 can be associated with the physical addresses A00014 to A00019, B00000 to B00001 and A00008 to A00013. The updating result is the second physical/logical address mapping table 1010 in FIG. 9 and the underline in the drawing presents an area in which data of the file identifier (management information area file1) exists.

In the processing described above, the reorganization processing for one CHANGE information of the reorganization journal 143 is completed and the sequence from reorganization of this file position information list 142 to updating of the physical/logical address mapping table 144 is handled as one processing unit. Even if a connection request of the reorganization object logical volume 160 to 162 is raised to the magnetic disk control apparatus 120 during the reorganization processing, updating of the management information area 170 becomes possible by completing this one processing unit without considering the interruption of the reorganization processing in the host computer 100.

In the file position information list 900 shown in FIG. 8, for example, the space area still remains fragmented. Therefore, the reorganization processing is successively executed. Here, the file identifier file2 is selected as the reorganization object and a continuous space area can be secured by moving an area 903 (logical addresses 00030 to 00044) of the area sequence number “1” to the position immediately after the file identifier file1. The movement result becomes an area 912 (logical addresses 00016 to 00030) in the file position information list 910 after the reorganization. The history at the time of the execution of the reorganization becomes the sequence ID0003 in the reorganization journal 143 in FIG. 4.

Furthermore, updating of the physical/logical address mapping table 144 is executed by first rewriting the movement starting point physical address in such a fashion as to associate with the movement destination logical address in the same way as described already. The movement starting point logical address is 00030 to 00044 and the movement destination logical address is 00016 to 00030 from the information of the sequence ID0003 in the reorganization journal 143 in FIG. 4. From this information together with the physical/logical address mapping table 1010 shown in FIG. 9, the physical addresses of the movement starting point are B00010 to B00019 and C0000 to C0004, and these are associated with the movement destination logical addresses 00016 to 00030. Next, rewriting is so made as to associate the movement destination physical address with the movement starting point logical address. At this time, 00030 in which the range of the movement starting point logical address overlaps with that of the movement destination logical address has already been rewritten for association, and it is 00016 to 00029 for the movement destination logical addresses and 00031 to 00044 for the movement starting point logical addresses that are to be rewritten. From this information together with the physical/logical address mapping table 1010 shown in FIG. 9, the movement destination physical addresses are A00008 to A00013 and B00002 to B00009, and these are associated with the movement starting point logical addresses 00031 to 00044.

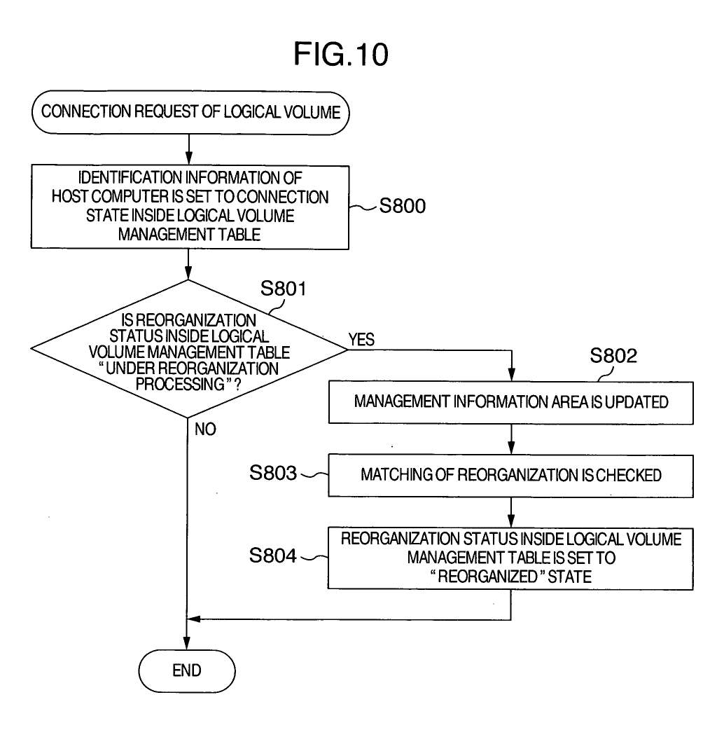

In the sequence ID0003 in FIG. 4, therefore, the physical/logical address mapping table 1010 is updated so that the logical addresses 00016 to 00044 can be associated with the physical addresses B00010 to B00019, C00000 to C00004, A00008 to A00013 and B00002 to B00009. The updating result is the third physical/logical address mapping table 1020 in FIG. 10 and the underline in the drawing represents the area in which the data exists. As a result, the area in which the data exists is the logical address 00000 to 00030 and the space area is the logical address 00031 to 00079, and the fragmentation state is solved.

As a result of the processing described above, the reorganization processing of the information managed by the magnetic disk control apparatus 120 is fully completed and the logical volume management program 132 again instructs the reorganization processing program 133 to calculate the fragmentation index. Here, the fragmentation index is calculated by using the file position information list 142 after reorganization and is stored in the logical volume management table 141 in the same way as described above.

As a result of the processing described above, reorganization of the file position information list 142 and updating of the physical/logical address mapping table 144 on the basis of the information of the former are executed at the time of the disconnection request of the logical volume 160 to 162. This processing is mostly executed inside the magnetic disk control apparatus 120 and does not use the resources of the host computer 100 other than the processing of the file position information generation program 101 of the host computer 100. The physical/logical address mapping table 144 is fragmented by the reorganization but this can be solved by periodically conducting the data relocation inside the magnetic disk control apparatus 120 as has been made in the prior art technology.

### <At connection request of logical volume>

FIG. 10 shows a reorganization processing flow at the time of the connection request of the logical volume. The reorganization processing at the time of the connection request of the logical volume executed by the CPU 130 will be hereinafter explained with reference to FIG. 10 (with appropriate reference to FIGS. 1 to 5).

When the host computer 100 requests the storage device 110 to establish connection with the logical volume 160 to 162, the CPU 130 executes the logical volume management program 132 inside the magnetic disk control apparatus 120, so that the identification information of the host computer 100 is set to the connection state 200 (with the object logical volume 160 to 162) inside the logical volume management table 141 (step S800). When the magnetic disk control apparatus 120 executes the reorganization processing of the object logical volume 160 to 162 at the time of the connection request, the reorganization processing is interrupted at the point at which the physical/logical address mapping table 144 is updated to set the state to the connectable state.

Next, to judge whether or not the position information list 142 of the object logical volume 160 to 162 is reorganized, whether or not the reorganization status 202 inside the logical volume management table 141 is “under reorganization” is judged (step S801). Here, the state of “under reorganization” represents that the reorganization is executed at the time of the previous disconnection request of the logical volume 160 to 162, and the management information inside the magnetic disk control apparatus 120 and the file position information recognized by the host computer 100 must be corrected. Therefore, the management information area 170 inside the logical volume 160 to 162 the host computer 100 looks up for acquiring the file position information is updated. To report updating of the management information area 170 from the magnetic disk control apparatus 120 to the host computer 100, a method that generates interruption is available. When the reorganization status is not “under reorganization” (“No” in step S801), the processing is completed.

When the reorganization statue is “under reorganization processing” (“Yes” in Step S801), the host computer 100 that receives the interrupt from the magnetic disk control apparatus 120 acquires the file position information list 142 reorganized and the reorganization journal 143 and updates the management information area 170 inside the logical volume 160 to 162 by using the reorganization journal 143 (step S802). As a result of reorganization of the file position information list 142 inside the magnetic disk control apparatus 120, the divided files are merged to a continuous area. Because the information quantity of the file position information list 142 becomes smaller than before the reorganization, this updating reduces the information quantity of the management information area 170.

When updating of the management information area 170 is completed, matching of reorganization is checked (step S803). In other words, matching with the file position information list 142 reorganized inside the magnetic disk control apparatus 120 at the time of the disconnection request of the logical volume 160 to 162 is checked. When non-matching is hereby detected, it is necessary to bring the management information area 170 and the physical/logical address mapping table 144 back to the state before reorganization. When reorganization can be made normally, the notice of completion of reorganization is given to the magnetic disk control apparatus 120 so that the logical volume management program 132 brings the reorganization status 202 inside the logical volume management table 141 into the “reorganized state” (step S804). After the procedures described above, the reorganization processing is completely finished.

According to the first embodiment explained above, it is possible to conduct relocation of data by rewriting (reorganizing) the data address information on the logical volume by the magnetic disk apparatus without movement of the physical data position. Consequently, because the data relocation that has been made in the past by the host computer is executed as the magnetic disk apparatus reorganizes the logical file position, and efficiency of the data access can be improved without applying a large load to the host computer. Because the setup of the existing file management system need not be changed, the application to the existing file system is easy. When the reorganization is executed when the magnetic disk apparatus and the host computer are cut off from each other, influences on the computer system under operation can be eliminated. In addition, because the management information of the logical volume is reorganized, the management information area can be reduced and the load to the CPU and to the memory during control by the host computer can be reduced. In comparison with the prior art technology in which the magnetic disk apparatus executes the data relocation without being controlled from the host computer, the drop of the access performance to the magnetic disk apparatus from the host computer can be mitigated even in the system in which the input/output response time of the magnetic disk apparatus exerts large influences such as in on-line systems. Because the physical data position is not moved, the trouble of the recovery operation can be reduced even when hardware of the magnetic disk apparatus fails.

### Second Embodiment

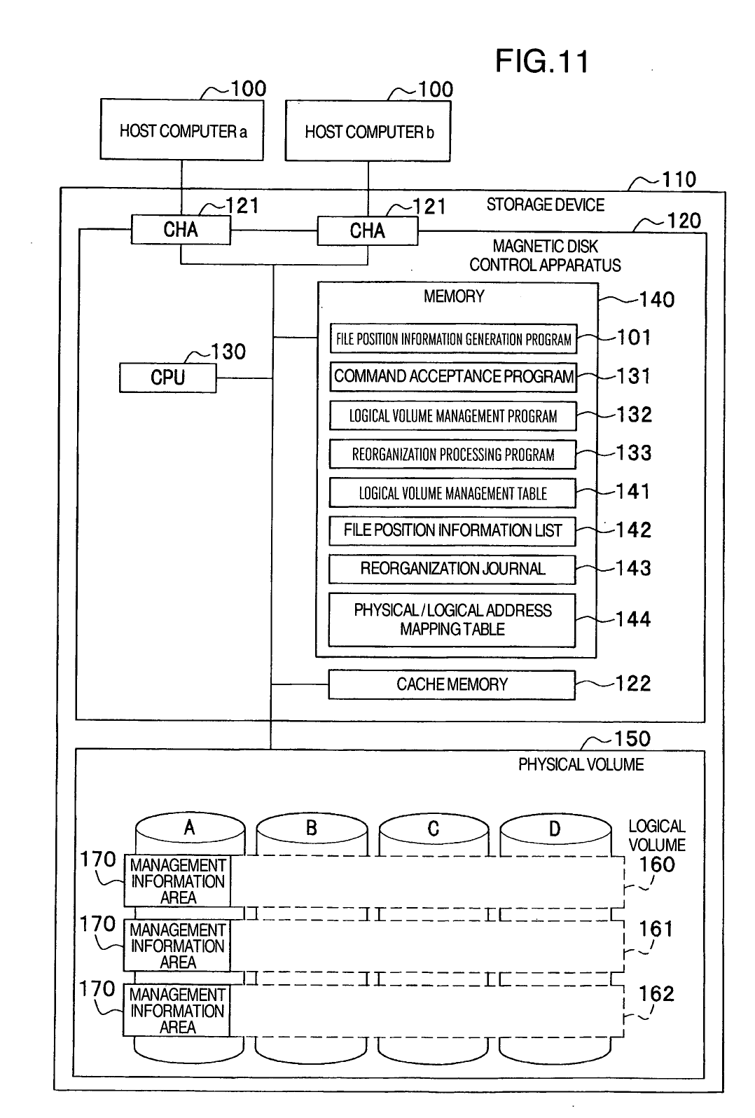

FIG. 11 shows a system construction according to the second embodiment of the invention. The difference of the construction from FIG. 1 resides in only the file position information generation program 101. In this embodiment, the file position information generation program 101 is provided as a function of the reorganization processing program 133 inside the magnetic disk control apparatus 120. In other words, the magnetic disk control apparatus 120 generates the file position information list 142 used at the time of reorganization. To generate the file position information list 142 inside the magnetic disk control apparatus 120, it is necessary for the magnetic disk control apparatus 120 to understand the file construction inside the logical volume 160 to 162. Therefore, a part of the file system is mounted to the reorganization processing program 133 so that the reorganization processing program 133 can update the management information area 170 inside the logical volume 160 to 162. In consequence, the load to the host computer 100 can be mitigated and all the reorganization processing can be fully executed in the magnetic disk control apparatus 120 at the time of the disconnection request of the logical volume 160 to 162.

The feature of the second embodiment to be hereby explained is as follows. That is, the magnetic disk control apparatus 120 has mounted thereto a part of the file system when the host computer 100 uses the logical volume 160 to 162. The term “a part” used hereby means a control portion for inputting and outputting the management information area 170 inside the logical volume 160 to 162 for reorganization and represents a minimum necessary system. In order for the magnetic disk control apparatus 120 side to take the file system into consideration and to generate the file position information list 142, a specific processing is not particularly required on the side of the host computer 100. However, when the information as the opportunity of the execution of reorganization is handed over, a control portion for handing over the information at the time of the disconnection request of the logical volume 160 to 162 is necessary. Hereinafter the second embodiment will be explained primarily about the difference from the first embodiment.

### <At Disconnection Request of Logical Volume>

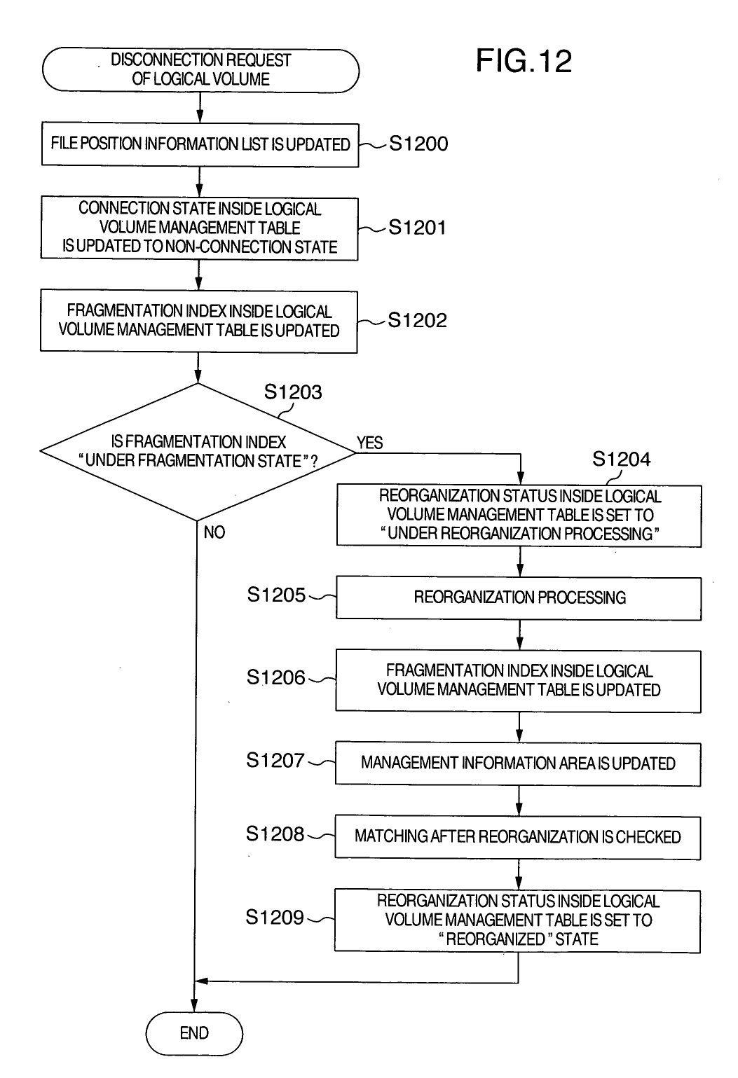

FIG. 12 shows a reorganization processing flow at the time of the disconnection request of the logical volume. The reorganization processing executed by the CPU 130 at the time of the disconnection request of the logical volume will be hereinafter explained with reference to FIG. 12 (with appropriate reference to FIGS. 2 to 5 and 11). When disconnection of the logical volume 160 to 162 is requested to the storage device 110, the logical volume management program 132 inside the magnetic disk control apparatus 120 instructs the reorganization process program 133 to generate the file position information list 142 and the CPU 130 executes the file position information generation program 101 to update the file position information list 142 (step S1200). Because a part of the file system is mounted, the reorganization processing program 133 can look up and update the management information area 170 on the logical volume 160 to 162 without relying on the host computer 100.

The processing of step S1201 to step S1206 is thereafter executed in the same way as step S601 to step S606 in the first embodiment. More concretely, the connection state 200 of the logical volume management table 141 is updated to the non-connection state, updating of the fragmentation index 201 of the logical volume management table 141 and judgment of necessity/non-necessity of the reorganization processing is made from the fragmentation index 201. When reorganization is necessary, the reorganization status 202 of the logical volume management table 141 is set to “under reorganization processing” and a processing for updating the reorganization processing and the fragmentation index 201 of the logical volume management table 141 to the information after updating is executed.

The processing of step S1207 to step S1209 is thereafter executed in the same way as step 802 to step 804 executed at the time of the connection request of the logical volume 160 to 162 in the first embodiment. More concretely, the management information area 170 is updated (step S1207). A concrete method gives the instruction of the reorganization of the management information area 170 from the logical volume management program 132 to the reorganization processing program 133 and updating of the management information area 170 is made by using the reorganization journal 143. After the execution of this reorganization, matching check of the management information area 170 is made by using the file position information list 142 so reorganized (step S1208). When the result of reorganization is normal, the reorganization statue inside the logical volume management table 141 is set to “reorganized” (step S1209) and the reorganization processing is completed.

### <Connection Request of Logical Volume>

The reorganization processing is not executed at the time of the connection request because the reorganization processing is completed at the time of the disconnection request of the logical volume in this embodiment.

It should be further understood by those skilled in the art that although the foregoing description has been made on embodiments of the invention, the invention is not limited thereto and various changes and modifications may be made without departing from the spirit of the invention and the scope of the appended claims.

1. A storage device control apparatus for controlling a storage device to be accessed from a computer, comprising:
a storage portion for storing file position information for associating a file identifier for identifying a file and a logical address of the file in the storage device; and
a processing portion for deciding the file identifier of the file as an object of reorganization of data, and acquiring the logical address of the file from the file position information having another file identifier coincident with the file identifier so decided.

2. The storage device control apparatus according to claim 1, wherein:
the storage portion stores physical/logical address mapping information for associating the logical address and a physical address of the file storage area in the storage device; and
the processing portion updates the logical address of the file position information by looking up the file position information so that the logical address of the file storage area so acquired is continuous to the logical address of other file storage area, and updates the physical/logical address mapping information by associating the logical address of the file position information after updating with the physical address corresponding to the logical address of the file storage area acquired.

3. The storage device control apparatus according to claim 2 wherein the processing portion looks up the file position information and decides file identifiers having a plurality of corresponding file storage areas as file identifiers of files as the object of data reorganization.

4. The storage device control apparatus according to claim 2 wherein the processing portion decides the file identifier of the file as the object of data reorganization when receiving a disconnection request from the storage device from the computer.

5. The storage device control apparatus according to claim 1, wherein:
the storage portion stores physical/logical address mapping information for associating the logical address and a physical address of the file storage area in the storage device; and
the processing portion updates the logical address of the file position information by looking up the file position information so that the logical address of the file storage area so acquired is continuous to the logical address of other file storage area, stores the logical address before updating and the logical address after updating in association with each other as reorganization history information, acquires physical addresses respectively corresponding to the logical address before updating and logical address after updating stored in the reorganization history information as a first and a second physical addresses from the physical/logical address mapping information, and updates the physical/logical address mapping information in such a fashion as to associate the logical address after updating and the first physical address, and updating the physical/logical address mapping information in such a fashion as to associate the logical address before updating and the second physical address.

6. A method for controlling a storage device by using a storage device control apparatus for controlling a storage device accessed from a computer, the storage device control apparatus including:
a storage portion for storing file position information for associating a file identifier for identifying a file and a logical address of the file in the storage device; and
a processing portion for processing information; and
the method comprising the steps of:
by the processing portion,
deciding the file identifier of the file as an object of reorganization of data, and
acquiring the logical address of the file from the file position information having another file identifier coincident with the file identifier so decided.

7. The method for controlling a storage device according to claim 6:
a storage portion stores physical/logical address mapping information for associating the logical addresses and physical addresses of the file storage area in the storage device; and
the method further comprising the steps of
by the processing portion,
updating the logical address of the file position information by looking up the file position information so that the logical address of the file storage area so acquired is continuous to the logical address of other file storage area, and
updating the physical/logical address mapping information by associating the logical address of the file position information after updating with the physical address corresponding to the logical address of the file storage area acquired.

8. The method for controlling a storage device according to claim 7, further comprising the steps of
by the processing portion,
looking up the file position information and;
deciding a file identifier having a plurality of corresponding file storage areas as file identifiers of files as an object of reorganization of data.

9. The method for controlling a storage device according to claim 7, further comprising the step of
by the processing portion,
deciding a file identifier of a file as the object of reorganization of data when receiving a disconnection request of the storage device from the computer.

10. The method for controlling a storage device according to claim 6, wherein:
the storage portion stores physical/logical address mapping information for associating the logical address and a physical addresses of the file storage area in the storage device; and
the method further comprising the steps of:
by the processing portion,
updating the logical address of the file position information by looking up the file position information so that the logical address of the file storage area so acquired is continuous to the logical address of other file storage area, and associating the logical addresses before updating and the logical addresses after updating stored in the reorganization history information with each other and storing them as reorganization history information in the storage portion,
acquiring the physical address before updating and the logical address after updating stored in the reorganization history information as a first and a second physical addresses from the physical/logical address mapping information,
updating the physical/logical address mapping information in such a fashion as to associate the logical address after updating with the first physical address and
updating the physical/logical address mapping information in such a fashion as to associate the logical address before updating with the second physical address.
